(19) United States
(12) Patent Application Publication
(10) Pub. No.: US 2010/0179872 A1
(43) Pub. Date: Jul. 15, 2010

(54) ELECTRONIC COUPON PROCESSING SYSTEM

(75) Inventors: Takeshi FUJITA, Tokyo (JP); Tsutomu Kawachi, Tokyo (JP); Keiichi Ogawa, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: SONY CORPORATION, Tokyo (JP)

(21) Appl. No.: 12/648,657

(22) Filed: Dec. 29, 2009

(30) Foreign Application Priority Data
Jan. 15, 2009 (JP) 2009-007059

(51) Int. Cl. G06Q 30/00; G06F 15/16

(52) U.S. Cl. 705/14.38; 709/204

(57) ABSTRACT

An electronic coupon processing system includes a plurality of user management server devices configured to register one or a plurality of different user identifiers and to register designated coupon information, and a center server device configured to register address information of a storage location of one piece or plural pieces of coupon information in association with identification information of a mobile device and to receive an inquiry about the coupon information from a shop terminal device.

### BACKGROUND OF THE INVENTION

1. Field of the Invention

The present invention relates to an electronic coupon processing system.

2. Description of the Related Art

A system for registering and managing an electronic coupon in a server is suggested (for example, Japanese Unexamined Patent Application Publication No. 2003-281430)

In the technology described in Japanese Unexamined Patent Application Publication No. 2003-281430, coupon information is registered with respect to a coupon DB server different from a user DB server having user information, and coupon information inquiry is performed with respect to the coupon DB server from a Pont of sale (POS) server. In the coupon DB server, a coupon ID and a user ID in an IC card are registered, and coupon information corresponding to the coupon ID from the POS server is provided to the POS server. Accordingly, a shop acquires the coupon information.

### SUMMARY OF THE INVENTION

However, in the above technology, since the registration of the coupon information of all users and inquiry of the coupon information from all shops via the POS server are performed with respect to the coupon DB server, a load is concentrated on the coupon DB server if a plurality of users or shops is present.

It is desirable to provide an electronic coupon processing system capable of preventing a load from being concentrated on a specific server even when a plurality of users or shops is present, and a user management server device available in the system.

According to an embodiment of the present invention, there is provided an electronic coupon processing system including a plurality of user management server devices configured to register one or a plurality of different user identifiers and to register designated coupon information; and a center server device configured to register address information of a storage location of one piece or plural pieces of coupon information in association with identification information of a mobile device and to receive an inquiry about the coupon information from a shop terminal device. Each of the plurality of user management server devices acquires the user identifier and the identification information of the mobile device, reports the address information of the storage location of the coupon information and the identification information of the mobile device to the center server device if the designated coupon information is registered in association with the user identifier and the identification information of the mobile device, and transmits the coupon information specified by the address information to the shop terminal device if a transmission request for designating the address information is received from the shop terminal device. The center server device receives the identification information of the mobile device from the shop terminal device and reports the address information of the storage location of one piece or the plural pieces of coupon information associated with the identification information of the mobile device to the shop terminal device if the received identification information of the mobile device is registered.

Accordingly, the registration of the coupon information at the user side is performed by any one user management server device. When the coupon information is used, since the shop terminal device can specify the user management server device in which the coupon information is registered from the address information, it is possible to acquire the coupon information from the user management server device in which the coupon information is registered even when a plurality of user management server devices is present. In a system for managing the coupon information without storing the coupon information in the mobile device, even when a plurality of users or shops is present and a plurality of user management server devices is present, it is possible to register and use the electronic coupon and a load is not concentrated on a specific server (for example, the center server device) in the system.

According to another embodiment of the present invention, there is provided a user management server device including a processing unit and a communication unit configured to perform network communication. The processing unit (a) acquires the identification information of the mobile device via the communication unit, (b) if designated coupon information is registered in association with the user identifiers and the identification information of the mobile device, reports address information of a storage location of the coupon information and the identification information of the mobile device to a center server device via the communication unit, and (c) if a transmission request for designating the address information is received from a shop terminal device which acquires the address information of the storage location of the coupon information from the center server device via the communication unit, transmits the coupon information specified by the address information to the shop terminal device.

Accordingly, in the user management server device, the registration of the coupon information by a user registered in the user management server device is performed and the registration of the coupon information by a user which is registered in another user management server device is not performed. To this end, a load due to the registration of the coupon information is distributed. In addition, when the coupon information is used, since the transmission or reception of the coupon information with the shop terminal device is performed, it is possible to reduce communication (data transmission volume, connection time or the like) between the shop terminal device and the center server device such that the load is not concentrated on the center server device. In the system for managing the coupon information without storing the coupon information in the mobile device, even when a plurality of users or shops is present and a plurality of user management server devices is present, the load is not concentrated on a specific server (for example, the center server device) in the system.

In the user management server device according to the embodiment of the present invention, in addition to the user management server device, the following configuration may be included. In this case, the processing unit may store issuance origin identification information of the issuance origin of the coupon information in association with the coupon information, and transmit the coupon information specified by the address information to the shop terminal device when a transmission request for designating the address information is received from the shop terminal device and the identification information of the issuance origin associated with the coupon information specified by the address information coincides with transmission origin identification information of a transmission origin of the transmission request.

Accordingly, since only the shop terminal device of the shop owner which is the issuance origin of the coupon information is permitted to transmit the coupon information, the coupon information is not erroneously transmitted to the shop terminal device of another provider.

In the user management server device according to the embodiment of the present invention, in addition to the user management server device, the following configuration may be included. In this case, the processing unit may specify a directory associated with the identification information of the mobile device when the identification information of the mobile device is acquired and report the address information of the storage location of a file of the coupon information and the identification information of the mobile device to the center server device when the file of the coupon information is stored in the directory.

Accordingly, since one piece or plural pieces of coupon information can be associated with the mobile device in the file system, it is possible to check the registration state of the coupon information on the file system.

In the user management server device according to the embodiment of the present invention, in addition to the user management server device, the following configuration may be included. In this case, the processing unit may provide display data for displaying a file system corresponding to the user identifier to a user terminal device, monitor a directory associated with the identification information of the mobile device in the file system, and report the address information of the storage location of the file of the coupon information and the identification information of the mobile device to the center server device when the file of the coupon information is stored in the directory based on an operation of the user terminal device.

Accordingly, the user can operate the user terminal device so as to perform the registration operation of the coupon information using the file system of the server side or check the registration state.

In the user management server device according the embodiment of the present invention, in addition to the user management server device, the following configuration may be included. In this case, the processing unit may receive a user identifier, execute user authentication based on the user identifier, and register the coupon information in association with the user identifier and the identification information of the mobile device when the user authentication is successful.

Accordingly, since the coupon information is managed in association with not the user identification information used for the user authentication but in association with the identification information of the mobile device, it is possible to reduce the possibility that the shop side or the like is informed of the user identification information.

In the user management server device according to the embodiment of the present invention, in addition to the user management server device, the following configuration may be included. In this case, the processing unit may receive key information input to the shop terminal device together with the transmission request and transmit the coupon information specified by the address information to the shop terminal device if the received key information coincides with key information which is registered in association with the coupon information in advance.

Accordingly, only a legal user who registers key information in advance can use the coupon.

In the user management server device according to the embodiment of the present invention, in addition to the user management server device, the following configuration may be included. In this case, the coupon information may be an image file in which privileges of an electronic coupon are described as an image and data or a file name.

Accordingly, since the user performs registration while viewing the privileges of the coupon information, it is possible to reduce the possibility that the coupon information different from the user's intention is registered.

According to the present invention, since coupon information processing is distributed, even when a plurality of users or shops is present, a load is not concentrated on a predetermined server.

### BRIEF DESCRIPTION OF THE DRAWINGS

FIG. 1 is a block diagram showing the configuration of an electronic coupon processing system according to Embodiment 1.

FIG. 2 is a block diagram showing the configuration of a user management server device in FIG. 1.

FIG. 3 is a block diagram showing the configuration of a user terminal device in FIG. 1.

FIG. 4 is a block diagram showing the configuration of a shop terminal device in FIG. 1.

FIG. 5 is a block diagram showing the configuration of a center server device in FIG. 1.

FIG. 6 is a diagram illustrating a process of registering an electronic coupon according to Embodiment 1.

FIG. 7 is a diagram of a display screen example of the user terminal device of the system shown in FIG. 1.

FIG. 8 is a diagram of an example of a directory structure of the user management server device of the system shown in FIG. 1.

FIG. 9 is a diagram illustrating a process of using an electronic coupon according to Embodiment 1.

FIG. 10 is a diagram of an example of a directory structure of the user management server device according to Embodiment 3.

### DESCRIPTION OF THE PREFERRED EMBODIMENTS

Hereinafter, the embodiments of the present invention will be described with reference to the accompanying drawings.

### Embodiment 1

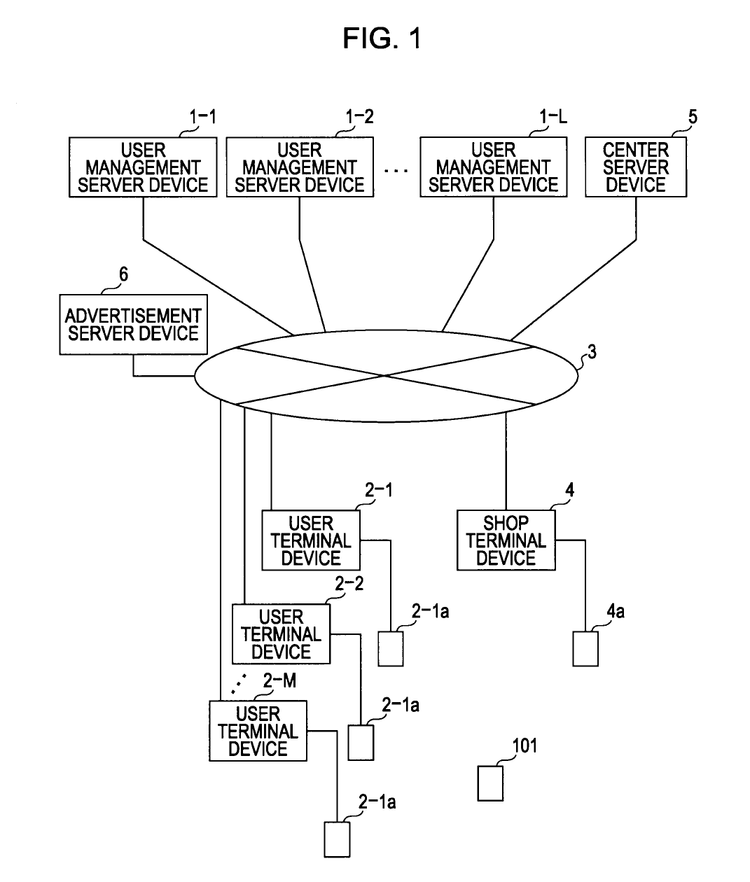

FIG. 1 is a block diagram showing the configuration of an electronic coupon processing system according to Embodiment 1. In this system, one or a plurality of different users is managed by a plurality of user management server devices 1-1 to 1-L.

In FIG. 1, the user management server device 1-i (i=1, 2, . . . , L, L>1) stores registration information (a user ID, a password or the like) of one or the plurality of users registered in the user management server device 1-i, performs user authentication based on the registration information and the user ID and the password of the user transmitted via a network 3 by a user terminal device 2-j operated by a user, and provides various types of services to a legal user.

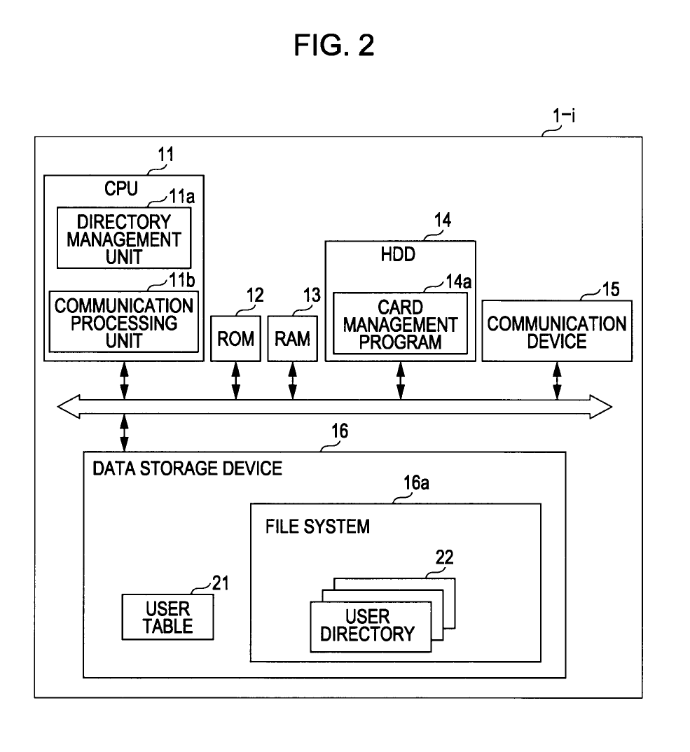

The user management server device 1-i has a computer included therein. FIG. 2 is a block diagram showing the configuration of the user management server device 1-i in FIG. 1. In FIG. 2, a CPU 11 is a processing unit for executing a program and executing a process described in the program. In addition, a ROM 12 is a non-volatile memory for storing a program and data in advance. In addition, a RAM 13 is a memory for temporarily storing a program and data when the program is executed. In addition, a HDD 14 is a hard disk drive device as a recording medium for storing an operating system (not shown) or a program such as a card management program 14a. A communication device 15 is connected to the network 3 so as to execute data communication with another device via the network 3. As the communication device 15, for example, a network interface card, a modem or the like is properly used.

The card management program 14a is executed by the CPU 11 such that a directory management unit 11a and a communication processing unit 11b are realized.

The directory management unit 11a has (a) a monitoring function for monitoring whether or not a file including coupon information is registered in a directory corresponding to an identification information of a mobile device 101 lower than a directory of a registered user and (b) a reading function for reading coupon information specified by address information when the communication processing unit 11b receives a transmission request for designating the address information from a shop terminal device 4 which acquires address information of a coupon information storage location from the center server device 5.

In addition, the communication processing unit 11b controls the communication device 15 so as to communicate with the user terminal devices 2-1 to 2-M, the shop terminal device 4, the center server device 5 and an advertisement server device 6 connected to the network 3. In Embodiment 1, the communication processing unit 11b has a function as a HyperText Transfer Protocol (HTTP) and can perform HTTP data communication with another device having an HTTP client function via the network 3. The communication processing unit 11b has an HTTP client function. The communication processing unit 11b has (a) an ID reception function for receiving the identification information of the mobile device 101 of the registered user from the user terminal device 2-j, (b) a notification function for notifying the center server device 5 of the address information of the storage location of the coupon information and the identification information of the mobile device 101 when the coupon information designated by the registered user registered in association with the registered user and the identification information of the mobile device 101 is detected by the directory management unit 11a, and (c) a coupon information transmission function for receiving a transmission request of the coupon information from the shop terminal device 4 and transmitting the coupon information specified by the address information designated by the transmission request to the shop terminal device 4.

A data storage device 16 can store a large amount of data and stores a user table 21 including the registration information of the user. The user table 21 may be realized by a database. In the data storage device 16, a file system 16a is formed and a user directory 21 is provided in the file system 16a as a storage region of registered users. As the data storage device 16, a hard disk drive device, a disk array device or the like is used.

In the user management server device 1-i, the CPU 11, the ROM 12, the RAM 13, the HDD 14, the communication device 15 and the data storage device 16 are connected to each other by a bus, a controller or the like so as to perform communication.

Next, the user terminal device 2-j (j=1, 2, . . . , M, M≧1) of FIG. 1 is a terminal device operated by the user registered in any one user management server device 1-i. As the user terminal device 2-j, a mobile telephone, a personal computer or the like is used. A reader 2-ja which can communicate with the mobile device 101 such as an IC card or a mobile telephone having an IC card function is connected to the user terminal device 2-j.

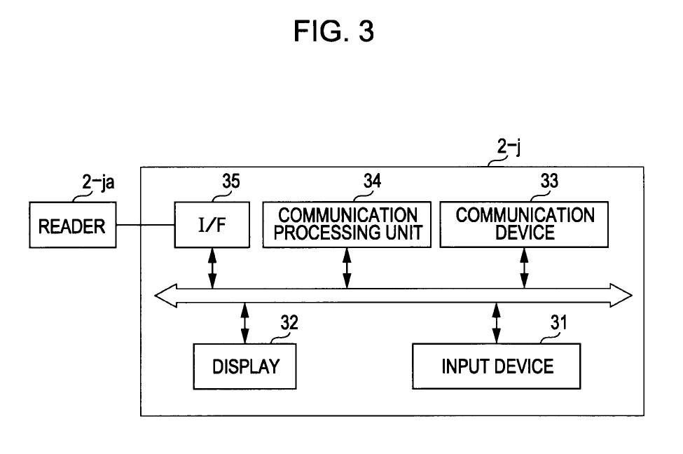

FIG. 3 is a block diagram showing the configuration of the user terminal device 2-j of FIG. 1. In FIG. 3, an input device 31 is a device for a keyboard, a key or the like for converting a user operation into an electrical signal. In addition, the reader 2-ja may be a portion of the input device 31. A display 32 is an output device for displaying a variety of information. A communication device 33 is connected to the network 3 so as to execute data communication with another device via the network 3. If the user terminal device 2-j is a personal computer, for example, a network interface card, a modem or the like is properly used as the communication device 33. If the user terminal device 2-j is a mobile device, a baseband portion or the like is used as the communication device 33. In addition, a communication processing process 34 controls the communication device 33 based on the user operation for the input device 31, accesses the user management server device 1-i and the advertisement server device 6 via the network 3, and transmits or receives a variety of information. The communication processing unit 34 is realized by a digital signal processor, a computer or the like. The communication processing unit 34 has an HTTP client function. The communication processing unit 34 has (a) an ID reading function for controlling the reader 2-ja via an interface 35 so as to read the unique identification information of the mobile device 101 and (b) a notification function for notifying the user management server device 1-i, in which a registered user logs, of the read unique identification information of the mobile device 101. The interface 35 is an interface circuit connected to the reader 2-ja. A peripheral interface such as a Universal Serial Bus (USB) interface is used as the interface 35. In addition, the HTTP client function of the communication processing unit 34 is realized by executing, for example, a web browser program by a computer or the like. The web browser program is stored in a recording medium such as a hard disk drive (not shown).

The network 3 of FIG. 1 properly includes a Local Area Network (LAN), a Wide Area Network (WAN) and the like. A private network is considered as the LAN and the Internet or the like is considered as the WAN. In addition, the network properly includes a wireless communication channel and a wired communication channel. The network 3 is an Internet Protocol (IP) network.

The shop terminal device 4 of FIG. 1 is a terminal device disposed in the shop of a provider which is an electronic coupon issuance origin. A personal computer, a POS terminal or the like is used as the shop terminal device 4. A reader 4a which may communicate with the mobile device 101 such as an IC card or a mobile telephone having an IC card function is connected to the shop terminal device 4.

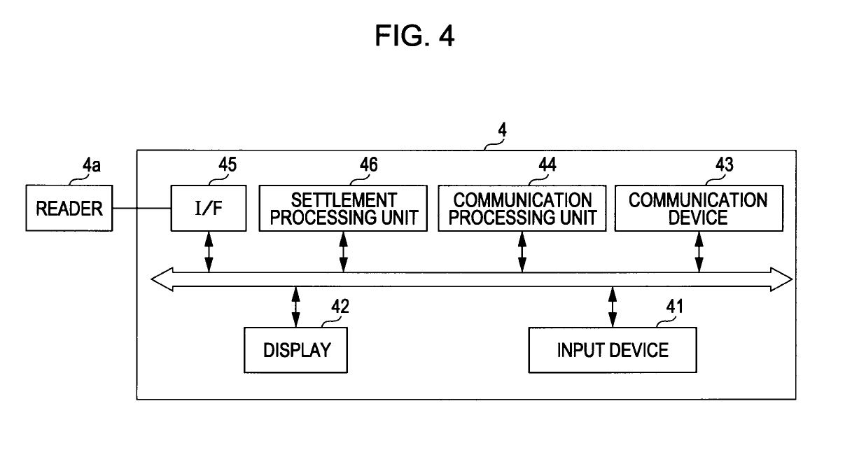

FIG. 4 is a block diagram showing the configuration of the shop terminal device 4 of FIG. 1. In FIG. 4, an input device 41 is a device for a keyboard, a key or the like for converting a user operation into an electrical signal. In addition, the reader 4a may be a portion of the input device 41. A display 42 is an output device for displaying a variety of information. A communication device 43 is connected to the network 3 so as to execute data communication with another device via the network 3. For example, a network interface card, a modem or the like is properly used as the communication device 43. In addition, a communication processing process 44 controls the communication device 43 based on the user operation for the input device 41, accesses the center server device 5 and the user management server device 1-i via the network 3, and transmits or receives a variety of information. The communication processing unit 44 has an HTTP client function. The communication processing unit 44 has (a) an ID reading function for controlling the reader 4a via an interface 45 so as to read the unique identification information of the mobile device 101 and (b) a coupon information acquisition function for accessing the center server device 5 and the user management server device 1-i so as to acquire coupon information associated with the mobile device 101. The interface 45 is an interface circuit connected to the reader 4a. A peripheral interface such as a USB interface is used as the interface 45. In addition, a settlement processing unit 46 applies coupon information so as to calculate a price to be paid to the shop by a user who is a customer. The communication processing unit 44 and the settlement processing unit 46 are realized by a digital signal processor, a computer or the like.

The center server device 5 of FIG. 1 registers the address information of the storage location of one piece or plural pieces of coupon information acquired by the registered user of any one user management server device 1-i in association with the identification information of the mobile device 101 and receives the inquiry of the coupon information from the shop terminal device. In Embodiment 1, the address information is described as a Uniform Resource Identifier (URI) such as a Uniform Resource Locator (URL). Accordingly, the user management server device 1-i in which the coupon information is registered is specified by the address information.

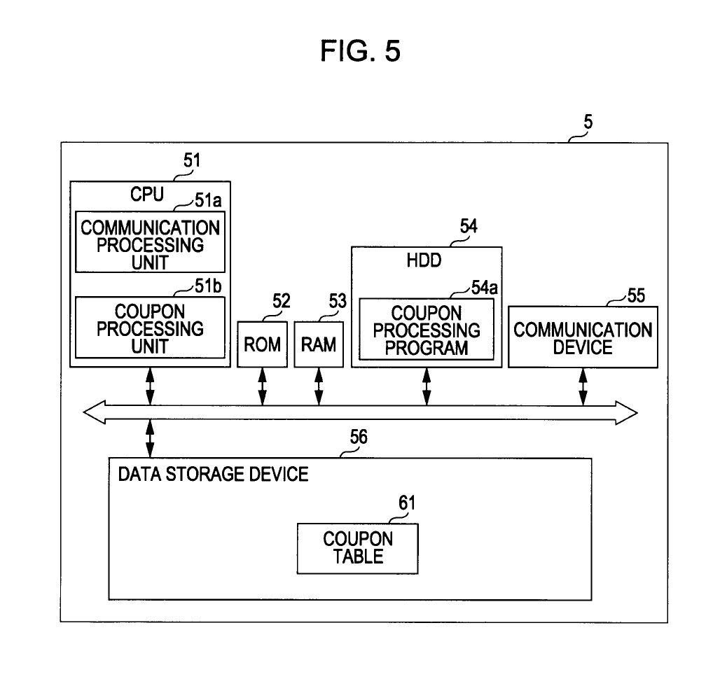

The center server device 5 has a computer mounted therein. FIG. 5 is a block diagram showing the configuration of the center server device 5 in FIG. 1. In FIG. 5, a CPU 51 is a processing unit for executing a program and executing a process described in the program. In addition, a ROM 52 is a non-volatile memory for storing a program and data in advance. In addition, a RAM 53 is a memory for temporarily storing a program and data when the program is executed. In addition, a HDD 54 is a hard disk drive device as a recording medium for storing an operating system (not shown) or a program such as a coupon processing program 54a. A communication device 55 is connected to the network 3 so as to execute data communication with another device via the network 3. As the communication device 55, for example, a network interface card, a modem or the like is properly used.

The coupon processing program 54a is executed by the CPU 51 such that a communication processing unit 51a and a coupon processing unit 51b are realized.

The communication processing unit 51a controls a communication device 55 so as to communicate with the shop terminal device 4 and the user management server devices 1-1 to 1-L connected to the network 3. In Embodiment 1, the communication processing unit 51a has an HTTP server function and can perform HTTP data communication with another device has an HTTP client function via the network 3. The communication processing unit 51a has (a) a reception function for receiving the address information of the storage location of the coupon information and the identification information of the mobile device 101 from the user management server device 1-i and (b) a response function for receiving the identification information of the mobile device from the shop terminal device 4 and notifying the shop terminal device 4 of the address information of the storage location of one piece or plural pieces of coupon information associated with the identification information of the mobile device 101 if the received identification information of the mobile device 101 is registered.

The coupon processing unit 51b has (a) a registration function for registering the address information of the storage location of the coupon information received by the communication processing unit 51a and the identification information of the mobile device 101 in the coupon table 61 and (b) an extraction function for referring to the coupon table 61 when the identification information of the mobile device 101 is received by the communication processing unit 51a and extracting the address information of the storage location of one piece or plural pieces of coupon information associated with the identification information of the mobile device 101 when the identification information of the mobile device 101 is registered in the coupon table 61.

A data storage device 56 can store a large amount of data and stores the coupon table 61 including the address information of the storage location of the coupon information and the identification information of the mobile device 101. As such a device, a hard disk drive device, a disk array device or the like is used. In the coupon table 61, the address information of the storage location of the coupon information is associated with the identification information of the mobile device 101.

In the center server device 5, the CPU 51, the ROM 52, the RAM 53, the HDD 54, the communication device 55 and the data storage device 56 are connected to each other by a bus, a controller or the like so as to perform communication.

The advertisement server device 6 of FIG. 1 has an HTTP server function and provides a web page including coupon information. In Embodiment 1, the coupon information is an image file such as Joint Photographic Experts Group (JPEG). In the image file, privileges of an electronic coupon are described by an image and, at the same time, are described by data or a file name. Hereinafter, a file transmitted or received as coupon information is referred to as a coupon file. In addition, the coupon information may be a data file in which privileges are described by data, instead of an image file. In addition, the description about the privileges may be included in the file name.

Next, the operation of each of the devices of the system will be described. In the system, mainly, (1) a process of registering an electronic coupon and (2) a process of using an electronic coupon is performed. Hereinafter, the processes will be described.

### (1) Process of Registering Electronic Coupon

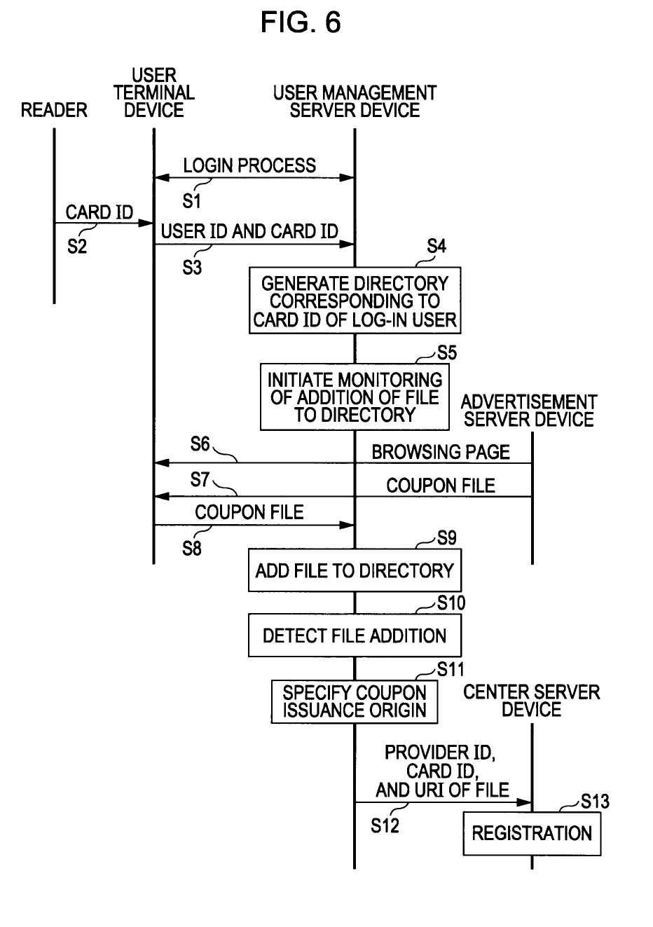

FIG. 6 is a diagram illustrating a process of registering an electronic coupon according to Embodiment 1 of the present invention. Hereinafter, the process of registering the electronic coupon will be described with reference to FIG. 6.

First, a user operates the user terminal device 2-j and logs in the user management server device 1-i in which the user is registered (step S1). At this time, the communication processing unit 34 of the user terminal device 2-j executes a web browser program based on the user operation of the input device 31, controls the communication device 33 when the URL of the login page is input with respect to the web browser displayed on the display 32 by the user operation, and acquires the web page of the URL via the network 3 according to the HTTP. Meanwhile, the communication processing unit 11b of the user management server device 1-i transmits a login page file when a command of the HTTP for specifying the URL is received via the communication device 15. When the login page file is acquired, the communication processing unit 34 of the user terminal device 2-j displays a login page on the display 32 based on the file. In the login page, when a user ID and a password (that is, the unique identification information of the user) are input by the user operation of the input device 31, the communication processing unit 34 transmits the user ID and the password to the user management server device 1-i. When the user ID and the password are received, the communication processing unit 11b of the user management server device 1-i refers to the user table 21, determines whether or not the login of the user is permitted, and specifies the user. If the user who operates the user terminal device 2-j is a legal user, the login of the user is permitted by the user management server device 1-i. The user management server device 1-i creates and transmits session information SID as user authentication information associated with the user ID to the user terminal device 2-j. The user terminal device 2-j receives and holds the session information SID by the web browser realized by the communication processing unit 34.

In this system, when the login of the user is permitted, the communication processing unit 11b provides a desktop environment to the user terminal device 2-j operated by the user. By the so-called Asynchronous JavaScript+XML (Ajax) technology, the desktop environment is provided to one window of the web browser of the user terminal device 2-j. In this desktop environment, the directory, the file and the like of the user management server device 1-i are displayed by icons so as to perform a file operation by a Graphical User Interface (GUI). Therefore, the user can operate the user terminal device 2-j so as to execute the file operation of a user directory 22 allocated to the user in the user management server device 1-i. The file operation includes the addition and deletion of a file, the read of a file, the read of a file in a directory and a list of a directory, the addition and deletion of a directory, and the like.

In a log-in state of the user, if the IC card which is the mobile device 101 is brought into contact with or approaches the reader 2-ja, the communication processing unit 34 of the user terminal device 2-j controls the reader 2-ja via the interface 35 and reads the card ID which is the unique device ID of the IC card (step S2). When the card ID is read, the communication processing unit 34 transmits the card ID and the session information SID of the user under log-in to the user management server device 1-i (step S3).

Here, several methods of acquiring the session information SID by the communication processing unit 34 may be considered. For example, if the session information SID is sent from the user management server device 1-i as a cookie, the communication processing unit 34 may read the session information SID of this cookie from the cache of the web browser. If the session information SID is sent as a variable of JavaScript (registered trademark) or a value of a hidden field an HTML file, the process of the communication processing unit 34 may directly access the process of the web browser and acquire the session information SID from HTML file data.

When the session information SID and the card ID are received, the communication processing unit 11b of the user management server device 1-i checks the log-in state of the user of the session information SID. The checking of the log-in state of the user is performed by determining whether or not a predetermined time elapses from when the access using the session information SID to the user management server device 1-i is at the end, and, when the predetermined time does not elapse, it is determined that the user is in the log-in state. If the user of the session information SID is in the log-in state, the directory management unit 11a determines whether or not a directory (hereinafter, referred to as a card directory) corresponding to the card ID is present under the user directory 22 corresponding to the user ID associated with the session information SID. If the card directory is not present, the directory management unit 11a generates the card directory (step S4). Subsequently, the directory management unit 11a initiates the monitoring of the directory (step S5). Therefore, it is periodically checked whether or not a file is newly added to the card directory. In addition, the card directory is, for example, generated using a card ID which is text data as a directory name. Meanwhile, in a desktop environment created in one window of the web browser of the user terminal device 2-j, a request is periodically issued in the user management server 1-i and the new creation of a directory or the like is monitored. When the card directory is created, the communication processing unit 11b reports the creation of the card directory as the response of the periodic monitoring. The web browser of the user terminal device 2-j displays an icon indicating the card directory on the desktop screen of the user terminal device 2-j. Meanwhile, if the card ID directory is already present, the icon indicating the card directory is already displayed on the desktop screen of the user terminal device 2-j when the desktop environment is provided.

In addition, file operation to the icon indicating the card directory and the card directory may be performed only while the corresponding IC card is disposed in a state of being readable by the reader 2-ja or may be performed after the IC card is detached from the reader 2-ja after reading the card ID. In either case, even when the IC card is detached from the reader 2-ja after reading the card ID, the card directory of the IC card is not deleted and is continuously held.

A card directory located under the user directory 22 of the registered user under log-in from the user terminal device 2-j is allocated to the mobile device 101 (here, the IC card). In addition, it is monitored whether a coupon file is newly added to the card directory.

Meanwhile, the user can browse the web page provided by the advertisement server device 6 using the web browser in the log-in state. For example, when the URL of the advertisement server device 6 is input to the input device 31 with respect to another window of the web browser of the user terminal device 2-j, the communication processing unit 34 acquires web page data of the URL from the advertisement server device 6 (step S6) and displays the web page on the display 32 based on the data. Such web page data is composed of one or a plurality of Hypertext Markup Language (HTML) files, image files and the like.

A coupon image included in such a web page is stored in the file system of the user terminal device 2-j and then copied to the icon of the above-described card directory or the window by a command operation within the desktop environment displayed in the web browser such that the user can acquire the electronic coupon.

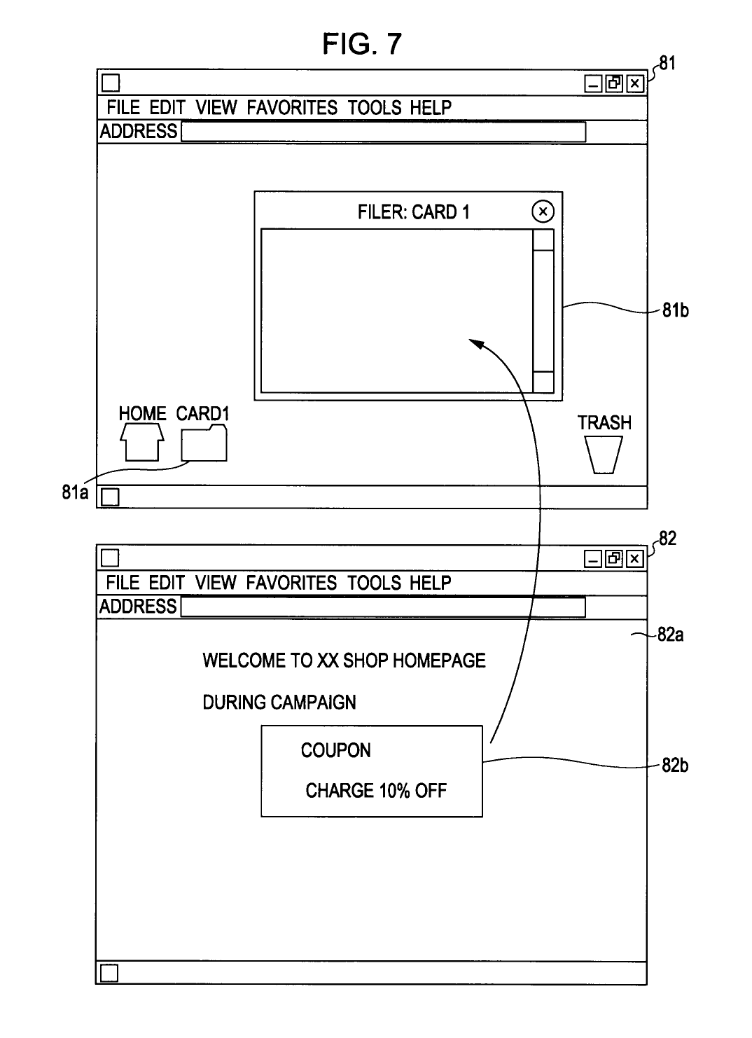

FIG. 7 is a diagram showing a display screen example of the user terminal device 2-j of the system shown in FIG. 1. For example, as shown in FIG. 7, the desktop is displayed on one window 81 under log-in. When the IC card is disposed in the reader 2-ja, an icon 81a indicating the card directory is displayed on the desktop screen. In addition, when a predetermined operation is performed with respect to the icon 81a, a window 81b of the card directory is opened. In this state, when the advertisement server device 6 is accessed in another window 82 of the web browser, a web page 82a of the advertisement server device 6 is displayed in another window 82. A coupon image 82b is included in the web page 82a.

By designating this coupon image 82b on the web browser and performing a predetermined operation, the image file of the coupon image 82b is kept in the file system of the user terminal device 2-j (step S7). Here, this image file becomes a coupon file. Thereafter, in the web browser for displaying the desktop environment provided by the user management server device 1-i, when the user performs a predetermined operation using the input device 31 of the user terminal device 2-j, a file upload dialog is displayed on the display 32. When the image file of the coupon image 82b kept in the file system of the user terminal device 2-j is designated by the user operation for the input device 31 and a predetermined transmission command is input, the communication processing unit 34 issues and associates an XMLHttp request with the user ID of the user under log-in in the user management server device 1-i, and transmits the image file of the coupon image 82b (step S8). The user management server device 1-i adds the image file of the coupon image 82b to the user directory 22 associated with the acquired user ID. Meanwhile, the desktop environment generated in one window of the web browser of the user terminal device 2-j monitors the new creation of a directory or the like. The monitoring is performed by, at the communication processing unit 34, periodically issuing a request to the user management server device 1-i and determining whether the new creation of the directory is performed from a response thereof. To this end, if the image file of the coupon image 82b is added, the communication processing unit 11b reports the addition of the image file as the response of the periodic monitoring. The communication processing unit 34 receives the report, in the desktop environment generated in one window of the web browser of the user terminal device 2-j, an icon indicating the image file of the coupon image 82b is displayed on the desktop screen of the user terminal device 2-j. In addition, when the user operation for moving the icon of the image file of the coupon image 82b to the region 81b for displaying the card directory is performed with respect to the input device 31, the communication processing unit 34 issues a command for moving the image file of the coupon image 82b to the card directory with respect to the user management server device 1-i in correspondence with the user operation. When this command is received by the communication processing unit 11b of the user management server device 1-i, the image file is moved to the card directory within the file system 16a by the directory management unit 11a (step S9). As described above, since the desktop environment generated in one window of the web browser of the user terminal device 2-j monitors the new creation of the directory or the like, the update of the display to which the movement of the image file of the coupon image 82b is reflected is performed.

Since the directory management unit 11a monitors the card directory, the addition of the coupon file to the card directory is detected when the card directory is added (step S10).

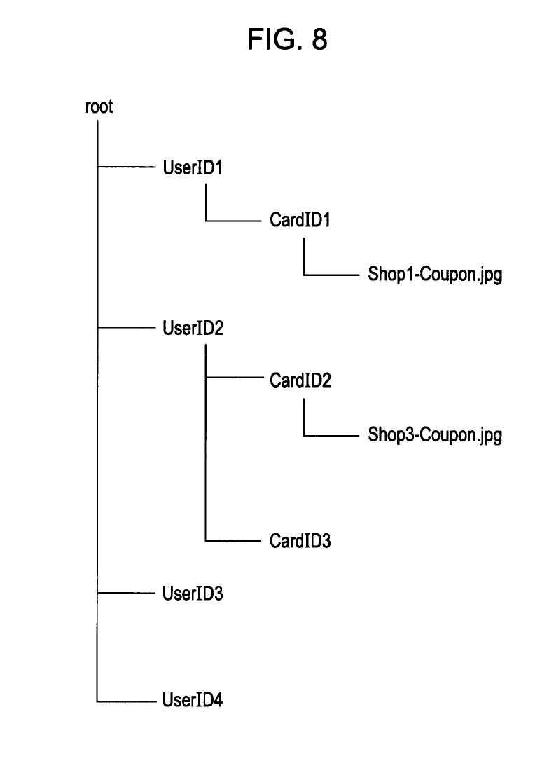

FIG. 8 is a diagram of an example of a directory structure of the user management server device 1-i of the system shown in FIG. 1. In the example shown in FIG. 8, a card directory “CardID1” is created under a user directory 22 “UserID1” and a coupon file “Shop1-Coupon.jpg” is stored in the card directory.

If the addition of the coupon file to the card directory is detected, the directory management unit 11a specifies a provider which is the issuance origin of the coupon file (step S11). At this time, for example, the directory management unit 11a extracts the user ID (hereinafter, referred to as a provider ID) of the provider described in the coupon file or inquires about the provider ID by reporting information such as the file name, the file size or the like of the coupon file to the server (not shown) on the network 3. Therefore, the directory management unit 11a acquires the provider ID of the provider which is the issuance origin of the coupon file. If the provider ID is described in the coupon file, for example, the coupon file may be set to a JPEG image file and the provider ID may be described as EXIF information or the technique described in Japanese Patent No. 3522635 may be used.

The directory management unit 11a registers the provider ID in association with the coupon file as the user ID of the user who is permitted to perform the access to the coupon file. At this time, the user ID of the user who is permitted to the access to the coupon file may be stored in the coupon file as attribute information or as an external table. In addition, the user who is permitted to perform the access to the coupon file is not limited to one user and may be a plurality of users or a user other than the provider which is the issuance origin of the coupon file. If not necessary, the provider which is the coupon file issuance origin may not be included in the user who is permitted to perform the access to the coupon file.

When the provider ID of the coupon file is acquired by the directory management unit 11a, the communication processing unit 11b transmits the provider ID, the card ID corresponding to the card directory in which the coupon file is stored and information other than the card ID for acquiring the coupon file to the center server device 5 (step S12). The information other than the card ID includes, for example, the URI as address information. The URI may be the URL of the coupon file or that obtained by adding a parameter for specifying the coupon file to the URL of a Common Gate Interface (CGI) functioning as a portion of the communication processing unit 11b and/or the directory management unit 11a.

In the center server device 5, when the communication processing unit 51a receives the provider ID, the card ID and the URI from the user management server device 1-i, the coupon processing unit 51b registers them in the coupon table 61 in association with them (step S13). The coupon processing unit 51b registers a flag indicating whether or not the coupon file is used in association with the URI of the coupon file. The initial value of the flag is a value indicating non-use.

At this time, the communication processing unit 11b of the user management device 1-i accesses the HTTP server of the communication processing unit 51a of the center server device 5 as the HTTP client function, and transmits data to the HTTP. For example, a POST command having data to be transmitted as a parameter is transmitted to the CGI of the center server device 5 and the process of step S13 is executed by the CGI.

Accordingly, the coupon file which is the identity of the electronic coupon is stored in the user management server device 1-i and the URI which is the address information of the storage location of the coupon file is stored in the center server device 5.

### (2) Process of Using Electronic Coupon

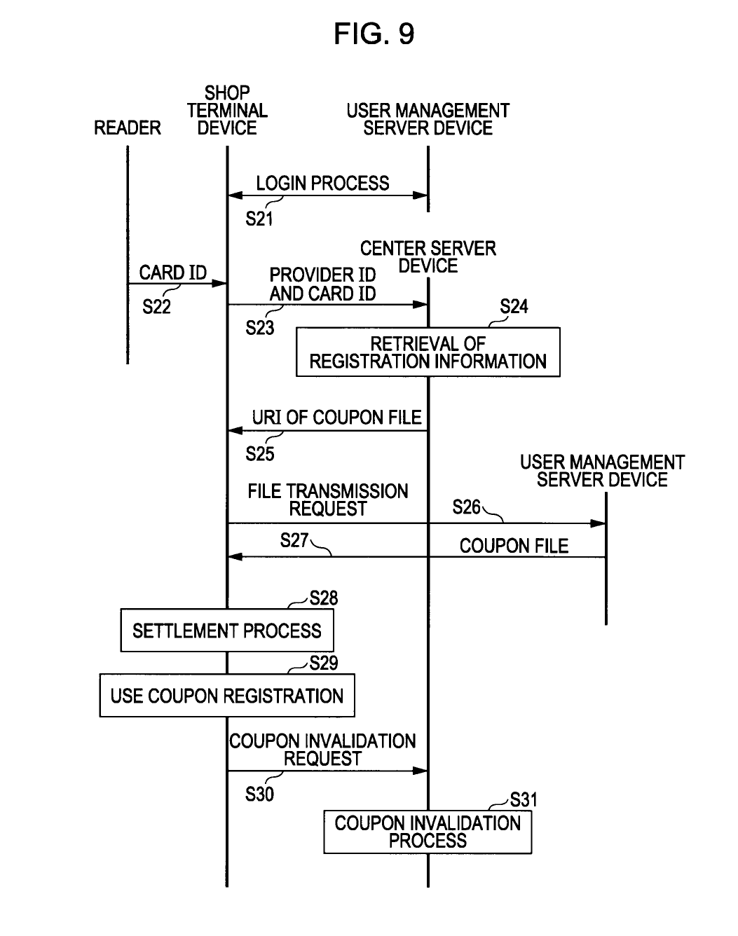

FIG. 9 is a diagram illustrating a process of using an electronic coupon according to Embodiment 1 of the present invention. Hereinafter, the process of using the electronic coupon will be described with reference to FIG. 9.

First, a provider operates the shop terminal device 4 and logs in a user management server device 1-S (S is any one of 1 to L) in which the provider is registered (step S21). Since the provider is one user, by the same process as the process of step S1, the legal provider inputs a user ID (that is, the provider ID) and a password such that log-in is permitted. However, the desktop environment may not be provided to the shop terminal device 4.

The provider holds the log-in state of the user management server device 1-S using the shop terminal device 4 when the shop is opened. A user who is a customer presents an IC card which is the mobile device 101 at the time of settlement in the shop.

When the IC card which is the mobile device 101 is brought into contact with or approaches the reader 4a in the log-in state of the provider, the communication processing unit 44 of the shop terminal device 4 controls the reader 4a via the interface 45 and reads the card ID which is the unique device ID of the IC card (step S22). When the card ID is read, the communication processing unit 44 transmits the card ID and the provider ID of the provider in the log-in state to the center server device 5 and inquires about the registered electronic coupon (step S23). In addition, the communication processing unit 44 has address information (a URL, an IP address or the like) of the center server device 5 in advance.

In the center server device 5, when the communication processing unit 51a receives the provider ID and the card ID, the coupon processing unit 51b retrieves the combination of the provider ID and the card ID which are registered in association with each other, by referring to the coupon table 61 (step S24).

At this time, the communication processing unit 44 of the shop terminal device 4 accesses the HTTP server of the communication processing unit 51a of the center server device 5 as the HTTP client function, and transmits data to the HTTP. For example, a GET command having data to be transmitted as a parameter is transmitted to the CGI of the center server device 5 and the process of step S24 is executed by the CGI.

When the inquired provider ID and card ID are found in the coupon table 61 by the coupon processing unit 51b, the communication processing unit 51a transmits the URI of the coupon file associated with the combination of the provider ID and the card ID as the response of the inquiry (step S25). However, if the value of the flag associated with the URI of the coupon file is a value indicating an already used state, the communication processing unit 51a does not transmit the URI of the coupon file as the response of the inquiry. Accordingly, if a URI of another corresponding coupon file is present, the URI is transmitted and, if the URI of another coupon file is not present, data indicating that the URI of the corresponding coupon file is not present is transmitted. Meanwhile, when the inquired provider ID and card ID are not found, the communication processing unit 51a transmits data indicating that the URI of the coupon file is not present as the response of the inquiry (step S25).

When the response of the inquiry is received from the center server device 5 and the URI is received as the response, the communication processing unit 44 of the shop terminal device 4 transmits a file transmission request for designating the received URI together with the provider ID of the shop terminal device 4 according to the HTTP (step S26). Since the URI indicates any one user management server device 1-i (that is, the user management server device 1-i in which the user who is the customer is registered, the file transmission request is received by the communication processing unit 11b of any one user management server device 1-i. The directory management unit 11a determines whether or not the provider ID is included in the user ID which is permitted to perform the access to the coupon file of the designated URI. Only when the provider ID is included in the user ID which is permitted to perform the access, the communication processing unit 11b transmits the coupon file of the designated URI to the shop terminal device 4 (step S27).

Meanwhile, if the URI of the coupon file is not present, the communication processing unit 44 of the shop terminal device 4 displays a message indicating that the electronic coupon associated with the presented IC card is not present on the display 42.

When the coupon file is acquired by the communication processing unit 44, the settlement processing unit 46 of the shop terminal device 4 acquires feature contents from the coupon file, reflects features, and calculates a price to be paid to the shop by the user who is the customer (step S28). At this time, if the mobile device 101 has an electronic money function, the settlement processing unit 46 may perform the settlement by the electronic money. In this case, the settlement processing unit 46 accesses an external server of an electronic money system via the network 3, a telephone line, a dedicated line or the like so as to perform the settlement process, if necessary.

Meanwhile, if the coupon file may not be acquired, the communication processing unit 44 of the shop terminal device 4 displays a message indicating that the electronic coupon associated with the presented IC card may not be acquired on the display 42.

Thereafter, if the settlement is finished, the shop terminal device 4 registers the information about the used coupon file and the card ID in a recording medium (not shown) as a history (step S29).

If the settlement is finished, the communication processing unit 44 of the shop terminal device 4 transmits a coupon invalidation request to the center server device 5 together with the URI of the coupon file used for the settlement (step S30).

In the center server device 5, when the coupon invalidation request and the URI are received by the communication processing unit 51a, the coupon processing unit 51b finds the URI by referring to the coupon table 61 and changes the value of the flag associated with the URI to the value indicating the already used state (step S31). Therefore, the used coupon file is registered as the already used state and thus is not reused.

As described above, the electronic coupon processing system according to Embodiment 1 includes the plurality of user management server devices 1-1 to 1-L and the center server device 5. Each user management server device 1-i acquires the identification information of the mobile device 101 of the registered user from the user terminal device 2-j, reports the address information of the storage location of the coupon information and the identification information of the mobile device 101 to the center server device 5 when the coupon information designated by the registered user is registered in association with the registered user and the identification information of the mobile device 101, and transmits the coupon information specified by the address information to the shop terminal device 4 according to the transmission request for designating the address information received from the shop terminal device 4. In addition, the center server device 5 receives the identification information of the mobile device 101 from the shop terminal device 4 and reports the address information of the storage location of one piece or plural pieces of coupon information associated with the identification information of the mobile device 101 to the shop terminal device 4 when the received identification information of the mobile device 101 is registered.

Accordingly, when the coupon information is used, since the shop terminal device 4 can specify the user management server device 1-i, in which the coupon information is registered, from the address information, although a plurality of user management server devices is present, the coupon information can be acquired from the user management server device in which the coupon information is registered. To this end, in the system for managing the coupon information without storing the coupon information in the mobile device 101, even when a plurality of users or shops is present and a plurality of user management server devices is present, it is possible to register and use the electronic coupon.

In addition, the registration of the coupon information from the user side is performed by any one user management server device 1-i. In the user management server device 1-i, the registration of the coupon information by a user registered in the user management server device 1-i is performed and the registration of the coupon information by a user which is registered in another user management server device 1-i is not performed. To this end, a load due to the registration of the coupon information is distributed. In addition, when the coupon information is used, since the transmission or reception of the coupon information between the user management server device 1-i and the shop terminal device 4 is performed, it is possible to reduce communication (data transmission volume, connection time or the like) between the shop terminal device 4 and the center server device 5 such that the load is not concentrated on the center server device 5. In the system for managing the coupon information without storing the coupon information in the mobile device, even when a plurality of users or shops is present and a plurality of user management server devices is present, the load is not concentrated on a specific server (for example, the center server device 5) in the system.

According to Embodiment 1, the user management server device 1-i specifies a shop owner who is the issuance origin of the coupon information, stores the provider ID of the specified shop owner in association with the coupon information, and transmits the coupon information specified by the address to the shop terminal device 4 when the transmission request for designating the address information is received from the shop terminal device 4 and the provider ID associated with the coupon information specified by the address information coincides with the provider ID of the shop terminal device which is a transmission origin of the transmission request. Accordingly, since only the shop terminal device 4 of the shop owner which is the issuance origin of the coupon information is permitted to transmit the coupon information, the coupon information is not erroneously transmitted to the shop terminal device 4 of another provider.

According to Embodiment 1, the user management server device 1-i specifies the directory associated with the identification information of the mobile device 101 when the identification information of the mobile device 101 is acquired and reports the address information of the storage location of the coupon file and the identification information of the mobile device 101 to the center server device 5 if the coupon file is stored in the directory. Accordingly, since one piece or plural pieces of coupon information can be associated with the mobile device 101 in the file system, it is possible to check the registration state of the coupon information on the file system.

According to Embodiment 1, the user management server device 1-i provides display data for displaying the file system allocated to the user to the user terminal device 2-j, monitors the directory associated with the identification information of the mobile device 101, and reports the address information of the storage location of the coupon file and the identification information of the mobile device 101 to the center server device 5 when the coupon file is stored in the directory based on the user operation of the user terminal device 2-j. Accordingly, in the user terminal device 2-j, the desktop environment is provided to the user based on the display data such that the user operates the user terminal device 2-j by the GUI so as to perform the registration operation of the coupon information using the file system of the server side or check the registration state.

According to Embodiment 1, a user ID different from the identification information of the mobile device 101 is used, the user management server device 1-i executes user authentication based on the user ID, and the coupon information is registered in association with the identification information of the mobile device 101 and the user with respect to only the registered user. Accordingly, since the coupon information is managed in association with not the user identification information used for the user authentication but in association with the identification information of the mobile device 101, it is possible to reduce the possibility that the shop side or the like is informed of the user identification information.

According to Embodiment 1, the coupon information becomes an image file in which privileges of the electronic coupon are described by an image, data or a file name. Accordingly, since the user performs registration while viewing the privileges of the coupon information, it is possible to reduce the possibility that the coupon information different from the user's intention is registered.

### Embodiment 2

According to an electronic coupon processing system according to Embodiment 2 of the present invention can register a plurality of electronic coupons of the same shop owner in association with the same IC card. The configuration of the electronic coupon processing system according to Embodiment 2 is equal to that of Embodiment 1, but the following functions are added.

In Embodiment 1, as described above, since the coupon information is stored in the card directory as the coupon file, it is possible to register a plurality of electronic coupons of the same shop owner in association with one IC card by storing the plurality of coupon files in the card directory.

In this case, when the IC card as the mobile device 101 is placed in the reader 4a of the shop terminal device 4, in the center server device 5, plural pieces of registration information are found from the coupon file 61.

In this case, the communication processing unit 51a of the center server device 5 transmits the plural pieces of registration information found by the coupon processing unit 51b to the shop terminal device 4.

In the shop terminal device 4, the communication processing unit 44 displays the plural pieces of registration information on the display 42 when the plural pieces of registration information are received. The plural pieces of registration information are presented to the user who is the customer. When the user operation for selecting one piece of registration information from the plural pieces of registration information is performed with respect to the input device 41, the communication processing unit 44 specifies the selected registration information based on operation information obtained from the input device 41 and acquires the coupon information from any one user management server device 1-i based on the registration information, similar to Embodiment 1.

The other operation of each device of the system according to Embodiment 2 is equal to Embodiment 1 and thus the description thereof will be omitted.

As described above, according to Embodiment 2, even when a plurality of electronic coupons of the same shop owner is registered in association with the same IC card, it may be selected which user's coupon file is used when the coupon is used.

### Embodiment 3

An electronic coupon processing system according to Embodiment 3 enables a plurality of users to use the same IC card. The configuration of the electronic coupon processing system according to Embodiment 3 is equal to that of Embodiment 1, but the following functions are added.

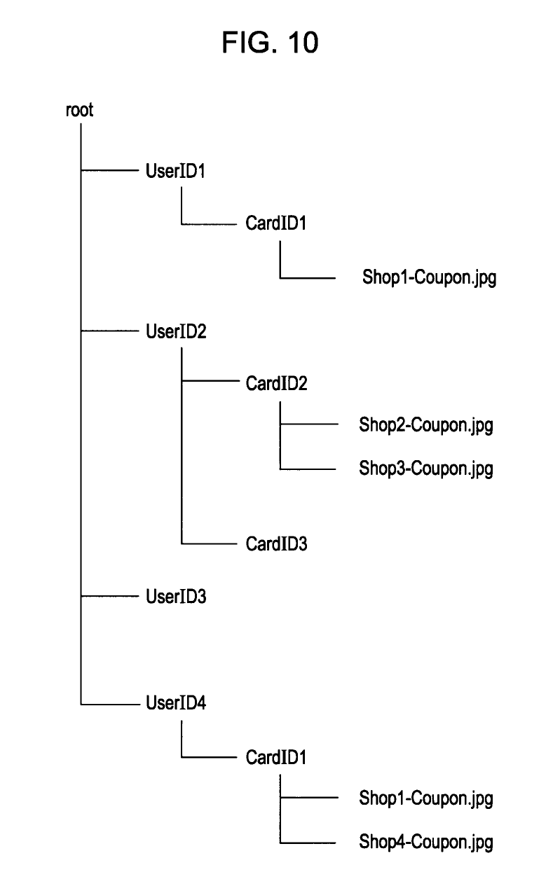

FIG. 10 is a diagram of an example of a directory structure of the user management server device 1-i according to Embodiment 3. The directory (for example, the above-described card directory) associated with the identification information of the mobile device 101 is created in association with the registered user, the directory of the same mobile device 101 is created under the plurality of user directories 22 when the mobile device 101 in which any user is in the log-in state is placed in the reader 2-ja and the same mobile device 101 in which another user is in the log-in state is placed in the reader 2-ja. In the example shown in FIG. 10, a card directory “CardID1” is present under a user directory “UserID1” and the card directory “CardID1” having the same name is also present under the user directory “UserID4”.

Accordingly, a plurality of users may register electronic coupons in association with the same mobile device 101. In the example shown in FIG. 10, the same coupon file “Shop1-Coupon.jpg” is stored in both the card directory “CardID1” under the user directory “UserID1” and the card directory “CardID1” under the user directory “UserID4”.

In such a registration state, in the center server device 5, plural pieces of address information are registered with respect to one coupon file associated with one mobile device 101. In the example shown in FIG. 10, if the address information is the URL, the domain name of the user management server device 1-i is “xxxx.com” and the provider ID is “Shop1”, address information http://xxxx.com/UserID1/CardID1/Shop1-Coupon.jpg, registration information including a card ID “CardID1” and a provider ID “Shop1”, address information http://xxxx.com/UserID4/CardID1/Shop1-Coupon.jpg and registration information including a card ID “CardID1” and a provider ID “Shop1” are stored in the center server device 5.

In this state, when the IC card of the card ID “CardID1” as the mobile device 101 is placed in the reader 4a of the shop terminal device 4, in the center server device 5, plural pieces of registration information are found from the coupon file 61.

In this case, the communication processing unit 51a of the center server device 5 transmits the plural pieces of registration information found by the coupon processing unit 51b to the shop terminal device 4.

In the shop terminal device 4, the communication processing unit 44 displays the plural pieces of registration information on the display 42 when the plural pieces of registration information are received. The plural pieces of registration information are presented to the user who is the customer. When the user operation for selecting one piece of registration information from the plural pieces of registration information is performed with respect to the input device 41, the communication processing unit 44 specifies the selected registration information based on operation information obtained from the input device 41 and acquires the coupon information from any one user management server device 1-i based on the registration information similar to Embodiment 1.

At the time of the user operation, key information such as a predetermined keyword for specifying a user may be simultaneously input. The shop terminal device 4 transmits this key information and the file transmission request based on the selected registration information to the user management server device 1-i in which the coupon file is stored. The user management server device 1-i determines whether the key information associated with the coupon file in advance coincides with the received key information and transmits the coupon file to the shop terminal device 4 when they coincide with each other. When they do not coincide with each other, error information is transmitted. On the basis of the determined result, the shop terminal device 4 continues to perform the process after checking whether the electronic coupon is used by a legal user. As the key information, bio information or the like of the user may be used.

The other operation of each device of the system according to Embodiment 3 is equal to that of Embodiment 1 and thus the description thereof will be omitted.

As described above, according to Embodiment 3, even when the coupon files are registered by the plurality of users in association with the same mobile device 101, it may be selected which user's coupon file is used when the coupon is used.

The above-described embodiments are suitable examples of the present invention, but the present invention is not limited thereto and various modifications or changes may be made without departing from the spirit of the present invention.

For example, in Embodiments 1 to 3, the provider of the center server device 4 and the providers which manage the user management server devices 1-1 to 1-L may be different. In addition, the provider of each user management server device 1-i may be different.

Although the number of center server devices 4 is one in Embodiments 1 to 3, a plurality of center server devices 4 may be placed. For example, the user management server device 1-i may report the address information of the coupon information or the like to the different center server devices 4 according to the type of the mobile device 101 (for example, the type of the IC card) and the shop terminal device 4 may inquire of the different center server devices 4 about the address information of the coupon information or the like according to the type of the mobile device 101.

In Embodiments 1 to 3, since the environment where the directory and file under the user directory 22 of each registered user can be browsed and operated in the user terminal device 2-j is provided by the user management server device 1-i, the registered user can check the coupon file registered by the registered user on the file system.

In Embodiments 1 to 3, the server devices 1-i, 5 and 6 may be configured by one computer or a plurality of computers.

Although, in Embodiments 1 to 3, the coupon file is transmitted to the shop terminal device 4 in step S27, only a portion of the information about the coupon file may be transmitted.

Although, in Embodiments 1 to 3, the already used coupon is not be used again in step S31, the number of times of using the coupon may be limited and the number of times of using the coupon may be reduced whenever the coupon is used. With the coupon invalidation request of step S30, the center server device 5 may delete the associated coupon information in the coupon table 61.

Although, in Embodiments 1 to 3, the issuance origin of the coupon invalidation request of step S30 may be the user management server device 1-i, and the coupon file stored in the user management server device 1-i may be deleted at the time of invalidation. In addition, the coupon file may have the information about the number of times the coupon may be validly used and the remaining number of valid uses of the coupon may be reduced whenever the coupon is used. This method may be combined with the coupon invalidation request to the center server device 5.

The present application contains subject matter related to that disclosed in Japanese Priority Patent Application JP 2009-007059 filed in the Japan Patent Office on Jan. 15, 2009, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An electronic coupon processing system comprising:
a plurality of user management server devices configured to register one or a plurality of different user identifiers and to register designated coupon information; and
a center server device configured to register address information of a storage location of one piece or plural pieces of coupon information in association with identification information of a mobile device and to receive an inquiry about the coupon information from a shop terminal device,
wherein each of the plurality of user management server devices acquires the user identifier and the identification information of the mobile device, reports the address information of the storage location of the coupon information and the identification information of the mobile device to the center server device if the designated coupon information is registered in association with the user identifier and the identification information of the mobile device, and transmits the coupon information specified by the address information to the shop terminal device if a transmission request for designating the address information is received from the shop terminal device, and
the center server device receives the identification information of the mobile device from the shop terminal device and reports the address information of the storage location of one piece or the plural pieces of coupon information associated with the identification information of the mobile device to the shop terminal device if the received identification information of the mobile device is registered.

2. A user management server device which registers one or a plurality of user identifiers and manages the user identifiers and identification information of a mobile device in association with each other, the user management server device comprising:
processing means and communication means configured to perform network communication,
wherein the processing means acquires the identification information of the mobile device via the communication means,
if designated coupon information is registered in association with the user identifiers and the identification information of the mobile device, reports address information of a storage location of the coupon information and the identification information of the mobile device to a center server device via the communication means, and
if a transmission request for designating the address information is received from a shop terminal device which acquires the address information of the storage location of the coupon information from the center server device via the communication means, transmits the coupon information specified by the address information to the shop terminal device.

3. The user management server device according to claim 2, wherein the processing unit stores issuance origin identification information of the issuance origin of the coupon information in association with the coupon information, and transmits the coupon information specified by the address information to the shop terminal device when a transmission request for designating the address information is received from the shop terminal device and the identification information of the issuance origin associated with the coupon information specified by the address information coincides with transmission origin identification information of a transmission origin of the transmission request.

4. The user management server device according to claim 2, wherein the processing unit specifies a directory associated with the identification information of the mobile device when the identification information of the mobile device is acquired and reports the address information of the storage location of a file of the coupon information and the identification information of the mobile device to the center server device when the file of the coupon information is stored in the directory.

5. The user management server device according to claim 4, wherein the processing unit provides display data for displaying a file system corresponding to the user identifier to a user terminal device, monitors a directory associated with the identification information of the mobile device in the file system, and reports the address information of the storage location of the file of the coupon information and the identification information of the mobile device to the center server device when the file of the coupon information is stored in the directory based on an operation of the user terminal device.

6. The user management server device according to claim 2, wherein the processing unit receives a user identifier, executes user authentication based on the user identifier, and registers the coupon information in association with the user identifier and the identification information of the mobile device when the user authentication is successful.

7. The user management server device according to claim 2, wherein the processing unit receives key information input to the shop terminal device together with the transmission request and transmits the coupon information specified by the address information to the shop terminal device if the received key information coincides with key information which is registered in association with the coupon information in advance.

8. The user management server device according to claim 2, wherein the coupon information is an image file in which privileges of an electronic coupon are described as an image and data or a file name.

9. A user management server device which registers one or a plurality of user identifiers and manages the user identifiers and identification information of a mobile device in association with each other, the user management server device comprising:
a processing unit and a communication unit configured to perform network communication,
wherein the processing unit acquires the identification information of the mobile device via the communication unit,
if designated coupon information is registered in association with the user identifiers and the identification information of the mobile device, reports address information of a storage location of the coupon information and the identification information of the mobile device to a center server device via the communication unit, and
if a transmission request for designating the address information is received from a shop terminal device which acquires the address information of the storage location of the coupon information from the center server device via the communication unit, transmits the coupon information specified by the address information to the shop terminal device.
